(19) United States
(12) Patent Application Publication
(10) Pub. No.: US 2002/0172191 A1
(43) Pub. Date: Nov. 21, 2002

(54) Call handling device

(76) Inventor: Simon Harrison, Buckinghamshire (GB)

Correspondence Address: BEYER WEAVER & THOMAS LLP, P.O. BOX 778, BERKELEY, CA, 94704-0778, US

(21) Appl. No.: 10/049,722

(22) PCT Filed: Jun. 13, 2001
(86) PCT No.: PCT/GB01/02600

(30) Foreign Application Priority Data
Jun. 13, 2000 (GB) 0014431.1
Dec. 4, 2000 (GB) 0029541.0

(51) Int. Cl. H04L 12/66; H04Q 7/00; H04B 1/69

(52) U.S. Cl. 370/352; 370/329; 375/132

(57) ABSTRACT

The present invention provides a call handling device for connecting a Bluetooth enabled communications device to a communications network. The call handling device includes at least two Bluetooth radios each of which is capable of maintaining a Bluetooth connection with the Bluetooth enabled communications device. A process is provided for controlling the Bluetooth connections and this is achieved such that if a first Bluetooth connections fails, or at least does not meet predetermined connection criteria, then a new second Bluetooth connection is established via a different radio. Accordingly, if the radios are located at distributed positions, this allows a user to maintain a Bluetooth connection even when they move out of range of the radio via which the connection is currently established.

### FIELD OF THE INVENTION

The present invention relates to a call handling device for connecting a wireless enabled communications device to a communications network, and in particular to a call handling device for handling voice type calls.

### BACKGROUND TO THE INVENTION

Currently, the majority of computer networks utilize some form of wiring for interconnecting the computers on the network. These systems suffer from the major drawbacks that wiring has to be installed within the building to enable the network to be fitted, and additionally, should a fault with the wiring develop, this can lead to the need for wiring to be replaced. In addition to this, the wiring can cause electromagnetic noise problems due to interference with other electrical equipment within the building, as well as only having a limited bandwidth. Furthermore, different networks require different wiring standards which further leads to the complexity of installing networks in buildings.

Wireless types of networks are now becoming more wide spread. Wireless communication can be broken down into one of three main categories, radio, cellular and local. Radio communications are used for mainly long distance work, and cellular communications are used for mobile phones and the like. At present, the cellular system can also be used to provide limited Internet access using WAP (Wireless Application Protocol) phones. Internet access is also possible via a cellular phone, a GSM modem and a PC/PDA.

In addition to this, the local communication standards are also provided for short-range radio communication. These systems have been used within the production of wireless networks.

One such short-range radio communication radio system is Bluetooth which can be used to provide customer premises wireless links for voice, data and multi-media applications.

A Bluetooth Radio Frequency (RF) system is a Fast Frequency Hopping Spread Spectrum (FFHSS) system in which packets are transmitted in regular time slots on frequencies defined by a pseudo random sequence. A Frequency Hopping system provides Bluetooth with resilience against interference. Interference may come from a variety of sources including microwave ovens and other communication systems operating in this unlicensed radio band which can be used freely around the world. The system uses 1 MHz frequency hopping steps to switch among 79 frequencies in the 2.4 GHz Industrial, Scientific and Medical (ISM) band at 1600 hops per second, with each channel using a different hopping sequence.

The Bluetooth baseband architecture includes a Radio Frequency transceiver (RF), a Link Controller (LC) and a Link Manager (LM) implementing the Link Manager Protocol (LMP).

Bluetooth version 1.1 supports asymmetric data rates of up to 721 Kbits per second and 57.6 Kbits per second and symmetric data rates of up to 432.5 Kbits per second. Data transfers may be over synchronous connections, Bluetooth supports up to three pairs of symmetric synchronous voice channels of 64 Kbits per second each.

Bluetooth connections operate in something called a piconet in which several nodes accessing the same channel via a common hopping sequence are connected in a point to multi-point network. The central node of a piconet is called a master that has up to seven active slaves connected to it in a star topology. The bandwidth available within a single piconet is limited by the master, which schedules time to communicate with its various slaves. In addition to the active slaves, devices can be connected to the master in a low power state known as park mode, these parked slaves cannot be active on the channel but remain synchronised to the master and addressable. Having some devices connected in park mode allows more than seven slaves be attached to a master concurrently. The parked slaves access the channel by becoming active slaves, this is regulated by the master.

Multiple piconets with overlapping coverage may co-operate to form a scatternet in which some devices participate in more that one piconet on a time division multiplex basis. These and any other piconets are not time or frequency synchronised, each piconet maintains is own independent master clock and hopping sequence.

The Bluetooth specification has therefore been designed for the primary purpose of allowing electronic devices to communicate with each other. Thus, the system is typically utilized in an environment in which one-to-one communication is achieved between two Bluetooth enabled devices.

In the situation in which voice communication is being provided, this will typically be achieved either using a handset, a Bluetooth enabled phone, or a voice communication enabled Bluetooth PDA. The user will utilize the Bluetooth device as a handset in the normal way. Signals are then transferred via a Bluetooth link to some form of connection to a network. Thus for example, this may be achieved by establishing a Bluetooth link with a desktop PC, or the like. Voice data received from the Bluetooth enable communications device will then be transferred from the PC to a local area network and then on either to a PBX (private branch exchange), the Internet (for voice over IP (VOIP)), or the PSTN (public switched telephone network).

However, the Bluetooth system is only capable of communicating over short distances. In addition to this, the Bluetooth specification does not include any protocol regarding the transfer of voice calls from one Bluetooth device to another. As a result, if the user's Bluetooth enable communications device is moved out of range of the desktop PC then Bluetooth connection between the communications device and the PC will be lost. As a result, the voice call will fail.

### SUMMARY OF THE INVENTION

In accordance with the present invention, we provide a call handling device for connecting a bluetooth enabled communications device to a communications network, the call handling device comprising:

at least two bluetooth radios, each radio being capable of maintaining a bluetooth connection between the call handling device and the bluetooth enabled communications device;

at least one port for connecting the call handling device to the communications network; and,

a processor for controlling the bluetooth connections, the processor being adapted to:

monitor a first bluetooth connection maintained by the radio in use;

compare the first bluetooth connection to predetermined connection criteria; and,

If the first bluetooth connection does not meet the predetermined connection criteria, establish a new second bluetooth connection via a different radio.

Accordingly, the present invention provides a call handling device for connecting the Bluetooth enabled communications device to a communications network. The call handling device includes at least two Bluetooth radios each of which is capable of maintaining a Bluetooth connection with the Bluetooth enabled communications device. A processor is provided for controlling the Bluetooth connections and this is achieved such that if a first Bluetooth connection fails, or at least does not meet predetermined connection criteria, then a new second Bluetooth connection is established via a different radio. Accordingly, if the radios are located at distributed positions, this allows a user to maintain a Bluetooth connection even when they move out of range of the radio via which the connection is currently established.

The processor is usually further adapted to break the first Bluetooth connection. Thus, it is only necessary to have one connection at any one time to allow the Bluetooth enabled communications device to communicate with the communications network. This allows the first Bluetooth connection to be broken if it does not meet the predetermined connection criteria thereby allowing the radio to be used to establish other Bluetooth connections.

The processor is usually adapted to establish the new second connection by selecting a different radio; establishing the second connection; and, breaking the first connection. However, this relies on the Bluetooth enabled communications device being able to simultaneously maintain two connections. This does not necessarily require the presence of two Bluetooth radios within the communications device, as the connections can be split between a given Bluetooth radio. However, this form of operation is not possible with all communications devices. Accordingly, in this case the processor can also be adapted to establish the new second connection by breaking the first connection; selecting a different radio; and, establishing the second connection. Accordingly, in this case the first connection is broken first allowing the second connection to be established.

In either case, the processor is preferably adapted to select a different radio by temporarily establishing one or more second Bluetooth connections, each second Bluetooth connection being established by respective different radios; monitoring and comparing each established second Bluetooth connection; and, selecting one of the second Bluetooth connections in accordance with the results of the comparison. Accordingly, this ensures that the best connection available is used to maintain communication between the communications device and the communications network. It will be appreciated by a person skilled in the art that in many cases, the communications device will be within range of several different radios simultaneously. Accordingly, this allows the radio which provides the best connection to be selected. In particular, because of the way in which Bluetooth functions even if communication is not currently being carried out via the different radios, a hopping sequence will be occurring in which the radios poll the Bluetooth enable communications device. Accordingly, it is generally possible to determine the signal strength using these temporarily established connections even if data itself is not being communicated via the respective connection.

Typically the processor monitors the signal strength of the Bluetooth connection. In this case, the predetermined connection criteria is a predetermined signal strength. As an alternative however, the processor can monitor the number of errors detected in a Bluetooth connection. In this case, a high number of errors suggests a poor connection such that the predetermined connection criteria is a predetermined number of errors in a predetermined amount of time. It will be appreciated that either of these methods allows the processor to determine via which radio the Bluetooth connection should be maintained.

The processor is preferably adapted to maintain the connection between the call handling device and the communications network whilst the second connection is established. This ensures that if a phone call is being made to a third party, for example, then the phone call itself remains in progress even when the first connection is being broken and the second connection is being established. This occurs because the third party is constantly connected to the call handling device even when the call handling device itself is not connected to the Bluetooth enable communications device. As a result of this, a short discontinuity may be noticed in the telephone call between the communications device and the communications network although this is preferable to having the call fail.

The processor is preferably adapted to establish the second connection using the Bluetooth headset profile. The Bluetooth specification provides a number of different profiles for handling voice communication between Bluetooth enabled devices. The majority of these profiles, such as the TCS (Telephony Control Protocol Specification), SCO (Synchronous Connection Orientated Link) or the normal cordless telephony profile, require the transfer of call set-up messages between the communicating devices to ensure that the connection is correctly established. The transfer of these call set-up messages takes a valuable amount of time and accordingly, if the second connection were made in such a manner this would result in a significant period of time lapsing between the initiation and the establishment of the second connection.

Accordingly, in order to avoid unnecessary discontinuities in the call, the present invention preferably uses the headset profile. The headset profile is provided for use with Bluetooth enabled headsets which are only capable of answering calls and not making calls. As a result, the headset profile does not include any set up messages. Instead, when a call is to be made to a headset, a signal is generated by the other communicating device causing the headset to automatically answer. Accordingly, the present invention uses the headset profile so that the call handling device can cause the Bluetooth enabled communications device to automatically answer a set up call. This allows the call handling device to initiate the second connection and have the Bluetooth enable connections device accept the connection within a minimal amount of time (typically less than one second), thereby reducing any discontinuities in the voice call.

Typically the communications device comprises one of a Bluetooth enabled headset, a Bluetooth enabled phone, a Bluetooth enabled PDA with voice communication facilities. However, any suitable Bluetooth enabled device, such as a laptop or the like may be used.

Typically the communications network is one of a PBX, PSTN, POTS, the Internet or the like. However, any communications network which allows voice type calls, such as normal telephone calls or VoIP calls to be made.

### BRIEF DESCRIPTION OF THE DRAWINGS

Examples of the present invention will now be described in detail with reference to the accompanying drawings, in which:

FIG. 1 is a schematic diagram of a network according to the present invention;

FIG. 2 is a schematic diagram of the Access Server of FIG. 1;

FIG. 3 is a schematic diagram of the Access Point of FIG. 1;

FIGS. 4 to 7 are examples of alternative network arrangements; and,

FIG. 8 is a schematic diagram showing the functionality of the Access Server and the Access Points.

### DETAILED DESCRIPTION

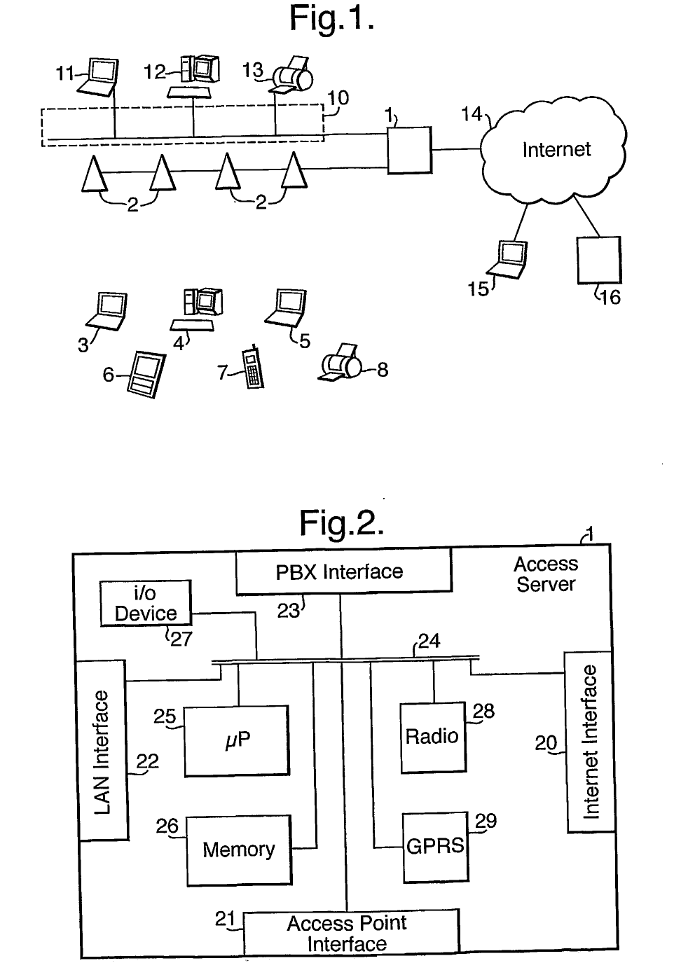

FIG. 1 shows a basic network arrangement according to the present invention. As shown, the network includes an Access Server 1 which is coupled to a number of local area network Access Points 2. The Access Points 2 are designed to communicate with a number of Bluetooth enabled communications devices 3,4,5,6,7,8 using Bluetooth connection.

In this scenario, the Bluetooth communication devices 3,4,5,6,7,8 can include devices such as a personal computer, laptop or the like which is fitted with a Bluetooth adapter, a specialised Bluetooth laptop, a Bluetooth enabled phone or mobile phone, a WAP Internet phone, a Bluetooth enabled personal data assistant (PDA) or a Bluetooth headset which are capable of establishing voice calls via the Bluetooth connections with the Access Points.

In fact under normal circumstances, the Access Server & Access Point can communicate with any Bluetooth enabled device. These include not only PCs, PDAs, and laptops but any of the following that have a Bluetooth port; a truck, a refrigerator, a baggage trolley, a keyboard etc, although this is not relevant for the purpose of the present invention.

The Access Server 1 is also optionally connected to a local area network 10 having a number of end stations 11,12,13. In this example, this allows the Access Server to be integrated with currently existing local area networks within a building.

The Access Server 1 can also be connected to a remote communications network 14, which in this example is the Internet This allows the communications devices coupled to the Access Server to communicate with remote users 15 or Access Servers of other remote sites 16.

Accordingly, the Access Points 2 allow voice calls to be made by and received by the Bluetooth communications devices 3,4,5,6,7,8 in turn allowing voice calls to be made using the LAN 10 and the Internet 14, via the Access Server 1. In this case, the Access Server operates as a call controller, as will be described in more detail below.

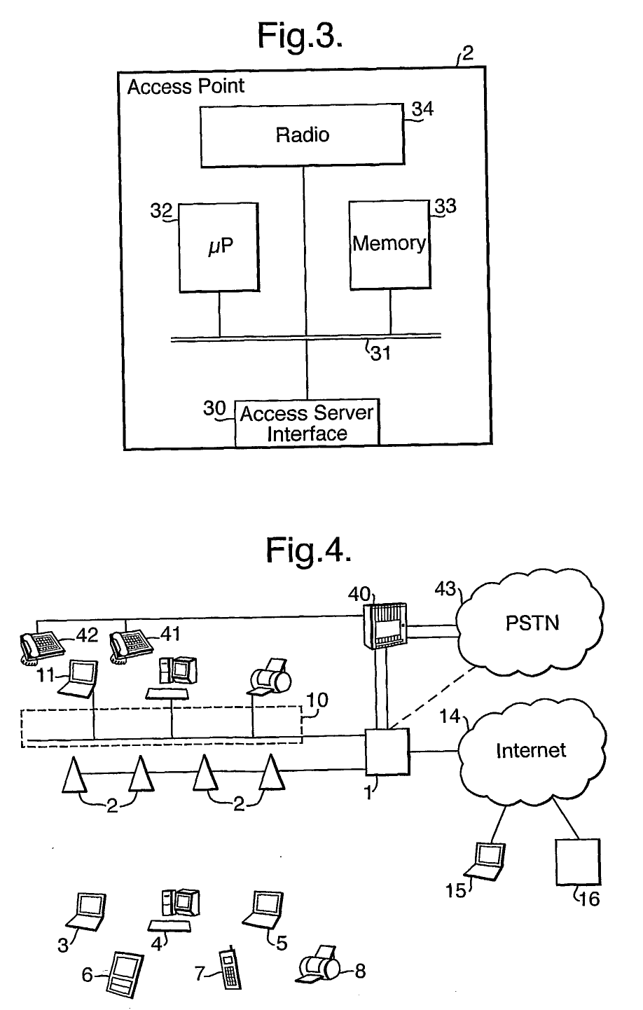

The Access Server is shown in more detail in FIG. 2.

The Access Server may include an Internet interface 20, an Access Point interface 21, a LAN interface 22 and a PBX interface 23, all of which are interconnected via a bus 24. A microprocessor 25 and a memory 26 which are provided for processing and storing the operating software, are also coupled to the bus 24. An input/output device 27 is also provided.

The processor 25 is typically an x86 type processor operating a Linux type operating system such as Red Hat Linux. This is particularly advantageous as the Linux system is widely used as the operating system for a number of different software applications. Accordingly, the system can implement a wide variety of standard operating software for network servers and the like, as well as allowing third parties the opportunity to modify existing software and develop their own software. However, any suitable form of processing system may be used.

In addition to these features, it is also possible to include a number of Bluetooth radios 28, and a GPRS transceiver 29, both of which are coupled to the BUS 24.

A range of radios are supported, including standard and enhanced range devices.

Similarly, the Bluetooth design of the Access Server and the Access Point offers capabilities beyond the basic Bluetooth specification. These include advanced control of Bluetooth device state to improve throughput, and control of broadcast and multicast traffic streams to/from Bluetooth devices.

In this example, four different interfaces 20,21,22,23 are shown. However, it is not essential for the Access Server 1 to include all of these interfaces, depending on the particular configuration which is to be used, as will be explained in more detail below.

Thus, in order to enable Bluetooth voice calls to be made between the Bluetooth communication devices and remote third parties, all that is required is for the Access Server to include the Access Point interface 21, with appropriately connected Access Points 2, and one of the Internet interface 20, the LAN interface 22, or the PBX interface 23, coupled to an appropriate communications device. Thus, for example, the LAN interface 22 could be coupled to an Ethernet phone via the LAN 10. Further examples will be described in more detail below. Alternatively, the Access Point interface need not be used if the Bluetooth radios 28 are used instead. However, this will become clearer when various network configurations used by the Access Server are described in more detail below.

The Internet interface 20 is used primarily for providing an ISDN connection to an Internet service provider. However, the system can be reconfigured to use Ethernet, DSL or a POTS modem for Internet connectivity. Thus, this allows VoIP calls to be transferred via the Internet 14.

The Access Point interface 21 is effectively an Ethernet interface which is adapted to operate with the Access Points, as will be explained in more detail below.

The LAN interface 22 is normally configured to be an Ethernet interface. However, this can be adapted to provide token ring or other forms of communication as required. Accordingly the LAN 10 can comprise an Ethernet, Token Ring or other similar network.

In order to be able to handle different communications protocols, each of the interfaces 20,21,22 will include a processor and a memory. The processor operates software stored in the memory which is appropriate for handling the required communications protocol. Thus in the case of the LAN interface 21, the default protocol is Ethernet. However, if alternative protocols such as Token Ring or ATM are used, then the software is adapted to translate the format of the data as it is transferred through the respective interface.

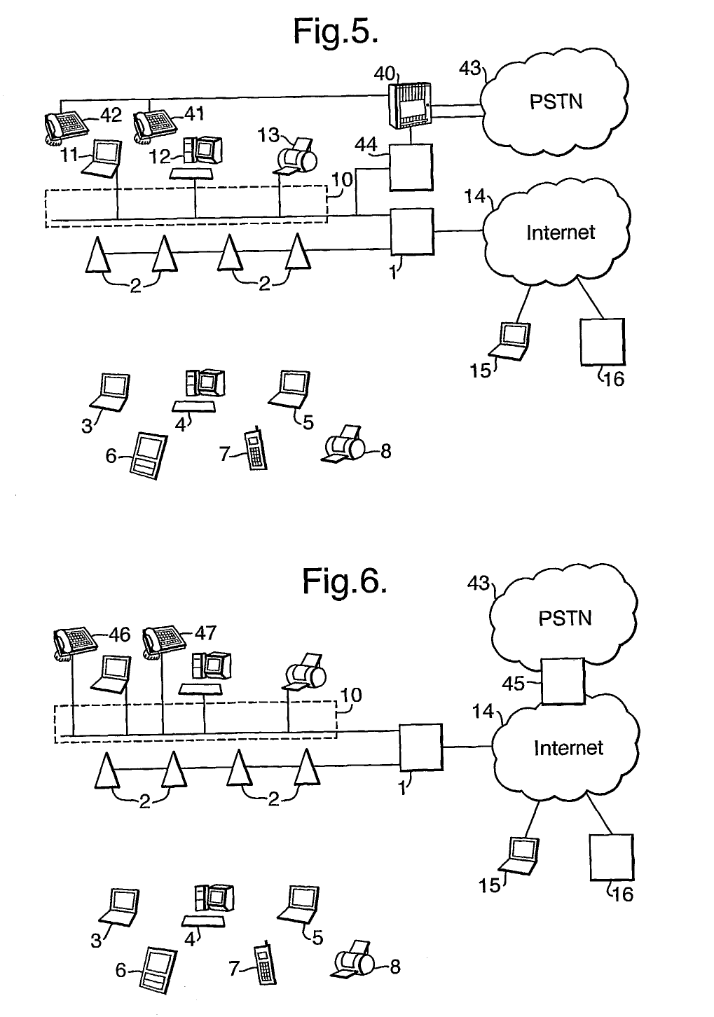

An Access Point according to the present invention is shown in FIG. 3. The Access Point includes an Access Server interface 30, for connecting the Access Point to the Access Server. The Access Server interface 30 is connected via a BUS 31 to a processor 32 and a memory 33. The BUS is also coupled to a number of Bluetooth radios 34 (only one shown) providing enhanced capabilities such as improved bandwidth and call density.

The processor 32 is typically a processor system that can include one or more processors, of the same or different types within the system. For example, the processor system could include, but is not be limited to, a RISC (Reduced Instruction Set Computer) processor and a DSP (Digital Signal Processor) processor.

In use, the Access Points are usually connected to the Access Point interface 21 using a daisy chain Ethernet connection. This is particularly advantageous as it allows a large number of Access Points 2 to be connected in series via a single wire to the Access Point interface 21. In this case, power can be supplied to the Access Points 2 either via the connection from the Access Server 1, or via separate power supplies (not shown) connected to each of the Access Points 2 as required.

As an alternative however, the Access Points 2 can be connected to the Access Server 1 via an Ethernet hub. This would allow a larger number of Access Points 2 to be connected to each Access Server 1.

In use, each Access Point 2 is able to communicate with a number of communications devices 3,4,5,6,7,8 which are in range of the respective radio 34. Any data received at the radio is transferred to the memory 33 for temporary storage. The processor 32 will determine from the data the intended destination. If this is another Bluetooth device within range of the Access Point, the data will be transferred via the radio 34 to the appropriate communications device 3,4,5,6,7,8. Otherwise the data will be transferred via the BUS 31 to the Access Server interface 30 and on to the Access Server 1.

Upon receipt of the data by the Access Server 1, the Access Point interface 21 will temporarily store the data in the memory whilst the processor determines the intended destination of the data. The processor may also operate to translate the format of the data, if this is necessary. The data is then routed by the Access Server to the intended destination on either the LAN 2, the Internet 14 or alternatively, to a PBX network, as will be described in more detail below.

The traffic from Bluetooth devices (arriving through an Access Point or the Access Server) can be sent to the LAN through a number of different mechanisms; one is routing, another uses a technique called Proxy ARP to reduce the configuration needed. These mechanisms are bi-directional and also connect traffic from the LAN to Bluetooth devices.

Similarly, data can be transferred from the Access Server, via the Access Point interface 21 to an Access Point 2. In this case, the Access Point 2 receives the data and transfers it into the memory 33. The processor 32 then uses the data to determine the intended destination communication device before routing the data appropriately.

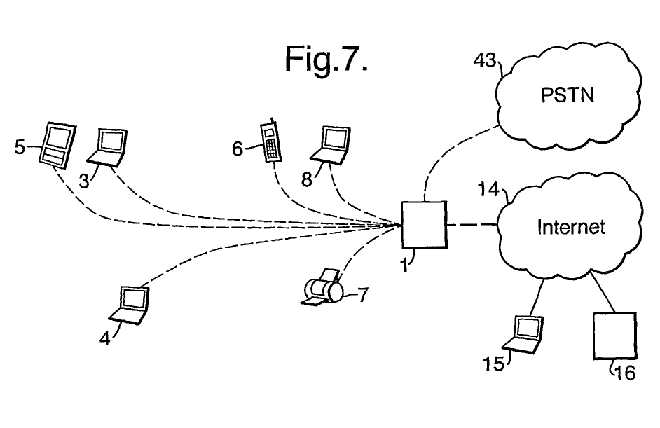

A number of different network configurations for transferring voice type calls via the Access Server are shown in FIGS. 4 to 7.

FIG. 4 shows an example in which a connection to a PBX 40 is implemented, the Access Server 1 will have the ability to associate communications devices 3,4,5,6,7,8 such as Bluetooth phones and handsets as extensions of the PBX. This allows Bluetooth enabled phones to call phones 41,42 on the PBX 40, as well as making calls to public telephone networks 43, such as the PSTN (Public Switched Telephone Network) or POTS (Plain Old Telephone System).

For example, this enables the Bluetooth phone or headset to ring at the same time, or instead of a users desk phone 41,42. Indeed, the invention enable the Bluetooth phone to have all the features offered by the PBX as a minimum functionality; on top of this, some new features can be added.

The use of Bluetooth 3-in-1 phones which are capable of both Bluetooth and cellular communications allows users to use their cellular phone as their desk phone when in the office.

Where the PBX has no appropriate support for ISDN, the Access Server PBX interface 23 can be connected directly to the public network 43 as shown by the dotted line, to provide direct dial-in and dial out to Bluetooth phones and headsets.

The Access Points 2 can also provide VoIP (Voice Over IP) connectivity to the Access Server, as shown in FIG. 5. In this example, the Access Server 1 is connected to the PBX 40 through a VoIP gateway 45 connected to the LAN. The Access Points implement voice compression algorithms hence providing a scalable VoIP solution (i.e. compression ability is increased with each Access Point).

In the example of FIG. 6, VoIP replaces the PBX 40 to allow connection to the telephone network 43. This is achieved by using a VoIP gateway 45 positioned between the Internet 14 and the phone network 43, to allow all phone calls to be transferred via the Internet 14 and the Access Server 1. In this example Ethernet phones 46,47 can connect directly to the LAN 10, whilst the Access Server 1 provides a gateway from Bluetooth phones and headsets to the Internet and hence on to the phone network 43.

In the example of FIG. 7, the GPRS system is used to provide constant on-line connection to the Internet. This is achieved using the GPRS transceiver 29 to provide the GPRS connection to the Internet 14, and the phone network 43, and using the Bluetooth radios 28 to provide the connection from the Access Server 1 to the communications devices 3,4,5,6,7,8. In circumstances where GPRS services do not provide sufficient bandwidth for all applications, the system may use dial-up ISDN to increase bandwidth. The always on full time connection to the Internet 14 provided by GPRS enables features such as VPN and public Web serving to be used, especially where additional bandwidth can be dialled up on demand.

In a mobile environment, it will be normal to use GSM phones for voice support. There may be added value in providing mobile voice connectivity via the Access Server.

Thus, the Access Server 1 provides wireless Internet and LAN access to a variety of Bluetooth enabled communications devices including PCs, printers, PDAs and WAP phones. It will also provide services specially tailored for PDAs through the use of OBEX (Object Exchange protocol) and WAP technology in the Access Server 1.

It will be appreciated from this that many users may be connected to the Access Server via the Access Points at any one time. Accordingly, it is necessary for the entire network system to operate a registration procedure to ensure that only authorised users of the system can have access.

Accordingly, the Access Server 1 stores a list of authorised users in the memory 26. In each case, a user name and password is provided for the user so that when they first access the system, the user name and password must be entered.

The Access Server and Access Point can implement a number of different security solutions. These range form low level authentication procedures inherent in Bluetooth devices, to high level security features which allow simple, easy to use and deploy services which operate in conjunction with or instead of Bluetooth specific security features. This allows a deployment of the Access Server & Access Point in a range of sites and applications.

Once this has been completed, the Access Server will associate a device indication with the associated user name and password. This ensures that a record is maintained of which device is being used by the user. Accordingly, any subsequent data addressed to the user can be sent directly to the device.

Thus, if the user is using a wireless communications device 3,4,5,6,7,8, the Access Server will store an indication of the device, either as a particular address, device identifier, or the like together with the user name and password. If any E-mail or the like is then received for that particular user, this can be directed to the device automatically.

The Access Server can store data concerning which radio 34,28 the user's communication device 3,4,5,6,7,8 is attached to. Every time a user's communication device 3,4,5,6.,7,8 moves from one radio 28,34 to another there is a disconnection and reconnection process. To make this as seamless as possible a “roaming” capability is operated by the processor to allow the controlled hand-off from one radio to another.

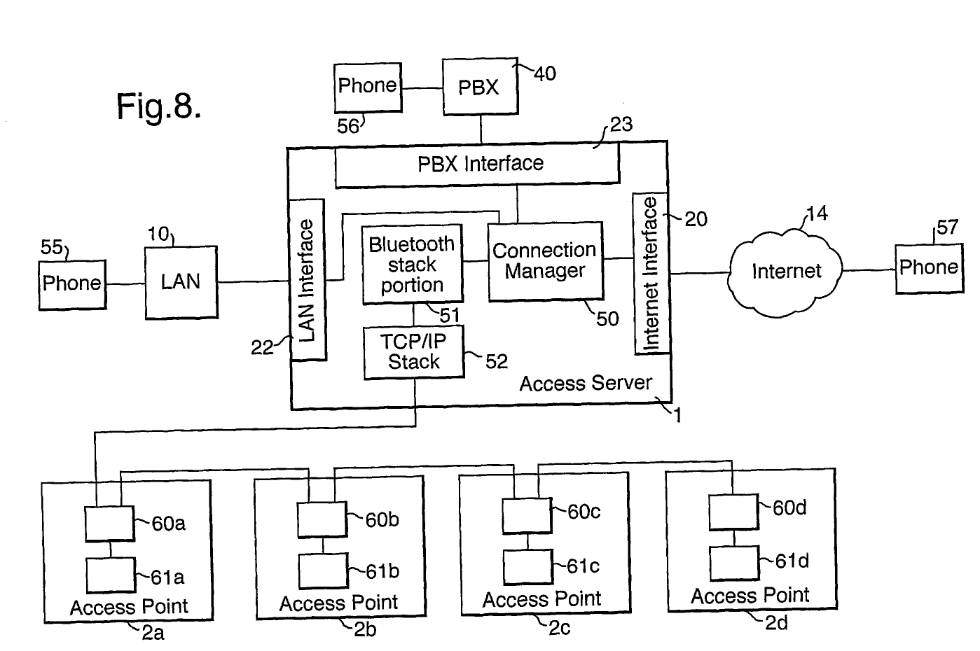

Operation of the Access Server to handle telephone calls using the “roaming” facility will now be described with reference to FIG. 8 which shows the functionality of the operation of the present invention.

As shown in this example, the Access Server 1 includes a connection manager 50 which is coupled to the Internet interface 20, the LAN Interface 22 and the PBX Interface 23, as well as being coupled to a Bluetooth stack 51 and a TCP/IP stack 52, as shown. The connection manager is a software implemented device which is typically implemented using the processor 25.

The Bluetooth stack 51 and TCP/IP stack 52 are also software implemented and again this may be achieved by the processor 25. More typically however, the Bluetooth stack and the TCP/IP stack are implemented by the processor in the Access Point interface 21. However, this is not important for the operation of the present invention.

In use, the connection manager 50 operates to provide control signals for controlling the operation of the Internet interface 20, the Access Point interface 21, the LAN interface 22 and the PBX interface 23. Similarly, the connection manager 50 controls the transfer of data through the Access Server 1.

In this example the Access Server is coupled to an Ethernet phone 55 via the LAN 10, to a standard telephone 56 via the PBX 40, and to an Internet phone 57, via the Internet 14.

As also shown in FIG. 8, the Access Points 2a-2d include respective TCP/IP stacks 60a-60d and Bluetooth stacks 61a-61d. Again, the TCP/IP stack and the Bluetooth stacks 60,61 may be implemented within the Access Server interface 30, or within the processor 32.

In use, data received at the Bluetooth radio 3, is typically temporarily stored in the memory 33 before being transferred to the processor 32. At this stage, the Bluetooth stack 61 is used to place the data into the Bluetooth HCI (Host Controller Interface) format suitable for transmission over a connection, such as an RS232 connection, in accordance with the Bluetooth specification.

In the present example, the data is transferred to the TCP/IP stack 60 which converts the data into a format suitable for transmission over the Ethernet connection to the Access Server 1.

Upon receipt of the data at the Access Server 1 the data is transferred to the TCP/IP stack 52 which converts the data back into the Bluetooth HCI format for transfer over an RS232 connection to the Bluetooth stack 51. The Bluetooth stack 51 operates to translate the data from HCI format into the basic payload data which can then be transferred onto one of the Internet interface 20, the LAN interface 22 or the PDX interface 23.

The routing of the data is achieved in accordance with routing information which is interpreted by the connection manager 50. The connection manager 50 also determines various information about the Bluetooth connection from the Bluetooth stack 51. This typically includes information concerning the signal strength between the Access Points 2 and the communications device 3,4,5,6,7,8 currently connected to the Access Point. The determination of the signal strength can be either a direct determination of the strength of signal that is required to communicate with the communications device, or alternatively or additionally, this may be an indication of the number of errors received per unit time.

The Access Server 1 can therefore be used for connecting calls between one of the communications devices 3,4,5,6,7,8 and any one of the phones 55,56,57. In this case, when the voice calls are established, the calls are typically initiated using either the headset or cordless telephony profiles depending on the type of communications device 3,4,5,6,7,8 being used.

In the case in which a headset is used for a call, the headset cannot be used to make the call but can only be used to receive calls. Accordingly, in this case, a call is received via one of the interfaces 20,21,22,23 from one of the phones 55,56,57 or from another communications device 3,4,5,6,7,8. The connection manager 50 determines that the call is to be routed to a communications device 3,4,5,6,7,8 and accordingly, transfers the call to an appropriate one of the Access Points 2a,2b,2c,2d.

In general, when a call is not being made the Access Points will in any event poll the communications devices 3,4,5,6,7,8 to determine if they require to send data via the respective Access Point 2a,2b,2c,2d. Accordingly, this poling will allow the connection manager 50 to determine the signal strength between each Bluetooth radio 34 in each Access Point 2a,2b,2c,2d and the communications device 3,4,5,6,7,8. In this case, the connection manager 50 will determine the Access Point 2a,2b,2c,2d which provides the best connection and transfer the data accordingly.

If the call is to be made using the headset profile, the connection manager 50 causes an SCO (Synchronous Connection Orientated Link) to be established as soon as the base band ACL (Asynchronous Connection-Less link) is in place. Thus there is no additional control protocol which delays the connection process. Accordingly, as soon as the call is established the communications device can be made to answer the call, thereby completing the connection process.

Alternatively, the call may be initially implemented using the cordless telephony profile and TCS (Telephony Control Protocol Specification). In this example, control messages will be transferred between the communication devices Access Serverhing to make the call.

Thus for example, if a communications device 3,4,5,6,7,8 is to make a call to a phone 55,56,57, it will wait to be polled by one of the Access Points 2a,2b,2c,2d. In response to the poling signal it will generate a control message which is transferred via the respective Access Point 2a to the Access Server. The control message will request connection with a respective phone 55,56,57 via either the Internet, the LAN 10, or the PBX 40. The connection manager therefore arranges for this control message to be transferred to the phone 55,56,57 as appropriate. Once the phone 55,56,57 has responded, the connection can be established.

This system works adequately when the signal strength is maintained between the communications device 3,4,5,6,7,8 and the respective Access Point 2a,2b,2c,2d. However, if the communications device is a portable device, such as a headset, mobile phone, portable phone with Bluetooth capability, or the like, then the signal strength will typically vary as the user moves relative to the respective Access Point 2a,2b,2c,2d.

Thus, for example the communications device 3,4,5,6,7,8 may initially be connected to the Access Server 1 via the Access Point 2a. However, as the user moves away from the Access Point 2a towards the Access Point 2b, the strength of the signal connecting the Access Point 2a communications device 3,4,5,6,7,8 will reduce.

During operation, the connection manager 50 constantly monitors the signal strength by monitoring either the strength of signal which must be used by the Access Point 2a to communicate with the device, or alternatively by monitoring the number of errors per unit time to determine the current signal strength.

If the signal strength drops below a predetermined threshold (or the number of errors rises above a predetermined threshold) then the connection manager 50 determines that an alternative connection is required. Accordingly, the connection manager 50 arranges for the call to be transferred via one of the other Access Points 2b,2c,2d. This can be achieved in a number of ways depending on the communications device being used.

Thus, for example the communications device 3,4,5,6,7,8 may be capable of establishing two Bluetooth connections simultaneously. In this case, the connection manager 50 will attempt to connect each of the Access Points 2b,2c,2d in turn to the communications device whilst it is simultaneously connected with the the Access Point 2a. The connection manager 50 will then determine the strength of each connection and then select the Access Point 2b,2c,2d having the strongest connection.

Thus, in this example, as the person using the communications device is moving towards the Access Point 2b then the strongest connection will be determined between the communications device and the Access Point 2b. As will be appreciated by a person skilled in the art, the determination of signal strength may be achieved whilst the Access Points 2b,2c,2d are poling the communications device. Accordingly, a full connection need not be established.

In this case, once the connection manager 50 has determined which of the Access Points 2b,2c,2d provides the strongest signal, the connection manager 50 will cause a new connection to be established. This new connection is initiated using the headset profile which does not require the transfer of call control messages.

Accordingly, the Access Server 1 maintains the connection with the phone 55,56,57, via one of the interfaces 20,22,23. Simultaneously, it causes a second connection to be opened between the Access Point 2b and the communications device 3,4,5,6,7,8 using the headset protocol. This is implemented in such a way that the communications device 3,4,5,6,7,8 automatically answers the call. Once this has been completed, the connection via the Access Point 2a can then be broken. In this case, the user of the communications device 3,4,5,6,7,8 or the phone 55,56,57 will not notice any interruption in communication.

However, in some alternative communications devices 3,4,5,6,7,8 only a single Bluetooth connection can be established at any one time. Accordingly, in this situation when the connection manager 50 determines that the signal strength is no longer sufficient to maintain the connection, the connection manager 50 breaks the connection between the Access Point 2a and the communications device. During this time the connection between the Access Server 1 and the phone 55,56,57 is maintained.

The connection manager 50 then arranges for the signal strength between the Access Points 2b,2c,2d and the communications device 3,4,5,6,7,8 to be determined. The connection manager achieves this by poling the communications device 3,4,5,6,7,8 with each of the Access Points 2b,2c,2d in turn. The connection manager 50 then determines the strongest connection and then operates to reactivate the connection with the communications device using the headset protocol. Again, the headset protocol is advantageously used as it can be used to cause the communications device to answer the call automatically.

Accordingly, using these techniques the user of the communications device 3,4,5,6,7,8 will not be aware that the connection has been changed from a connection via the Access Point 2a to a connection via the Access Point 2b. The customer is therefore completely passive throughout this entire operation.

1. A call handling device for connecting a bluetooth enabled communications device to a communications network, the call handling device comprising:
at least two bluetooth radios, each radio being capable of maintaining a bluetooth connection between the call handling device and the bluetooth enabled communications device;
at least one port for connecting the call handling device to the communications network; and,
a processor for controlling the bluetooth connections, the processor being adapted to:
monitor a first bluetooth connection maintained by the radio in use;
compare the first bluetooth connection to predetermined connection criteria; and,
if the first bluetooth connection does not meet the predetermined connection criteria, establish a new second bluetooth connection via a different radio.

2. A call handling device according to claim 1, wherein the processor is further adapted to break the first bluetooth connection.

3. A call handling device according to claim 2, wherein the processor is adapted to establish the new second connection by:
selecting a different radio;
establishing the second connection; and,
breaking the first connection.

4. A call handling device according to claim 2, wherein the processor is adapted to establish the new second connection by:
breaking the first connection;
selecting a different radio; and,
establishing the second connection.

5. A call handling device according to claim 3 or claim 4, wherein the processor is adapted to select a different radio by:
temporarily establishing one or more second bluetooth connections, each second bluetooth connection being established via a respective different radio;
monitoring and comparing each established second bluetooth connection; and,
selecting one of the second bluetooth connections in accordance with the result of the comparison.

6. A call handling device according to any of the preceding claims, wherein the processor monitors the signal strength of bluetooth connections.

7. A call handling device according to claim 6, wherein the predetermined connection criteria is a predetermined signal strength.

8. A call handling device according to any of the preceding claims, wherein the processor monitors the number of errors detected in the bluetooth connection.

9. A call handling device according to claim 8, wherein the predetermined connection criteria is a predetermined number of errors in a predetermined amount of time.

10. A call handling device according to any of the preceding claims, wherein the processor is adapted to maintain the connection between the call handling device and communications network whilst the second connection is established.

11. A call handling device according to any of the preceding claims, wherein the processor is adapted to establish the second connection using the bluetooth headset profile.

12. A call handling device according to any of the preceding claims, wherein the communications device comprises one of a bluetooth enabled headset, a bluetooth enabled phone, or a bluetooth enabled PDA with voice communication facilities.

13. A call handling device according to any of the preceding claims, wherein the communications network is one of a PBX, PSTN, POTS or the Internet.
